(19) United States
(12) Patent Application Publication
(10) Pub. No.: US 2026/0158826 A1
(43) Pub. Date: Jun. 11, 2026

(54) Heavy Goods Vehicle Tire with Complex Tread Pattern

(71) Applicant: COMPAGNIE GENERALE DES ETABLISSEMENTS MICHELIN, CLERMONT-FERRAND (FR)

(72) Inventors: Xavier ROBIN, Clermont-Ferrand Cedex 9 (FR); Damien BARDIN, Clermont-Ferrand Cedex 9 (FR); Arnaud LARREGAIN, Clermont-Ferrand Cedex 9 (FR); Magdalena KRAJEWSKA, Clermont-Ferrand Cedex 9 (FR)

(21) Appl. No.: 18/707,622

(22) PCT Filed: Oct. 26, 2022
(86) PCT No.: PCT/FR2022/052031

§ 371 Date: May 6, 2024

(30) Foreign Application Priority Data
Nov. 4, 2021 (FR) FR2111728

(51) Int. Cl. B60C 11/03

(52) U.S. Cl. CPC B60C 11/04; B60C 11/0323; B60C 11/045; B60C 11/1323; B60C 2011/0353; B60C 2200/06

(57) ABSTRACT

A tire (1) for a heavy-duty vehicle having a tread (2) with at least one complex circumferential cut (41, 42), consisting of an alternation of external cavities (61, 62), which open onto the tread surface (3), and of internal cavities (71, 72), which are hidden inside the tread (2), and aims to reduce its sensitivity to irregular wear. At least one complex circumferential cut (61, 62) has only one of its two walls (81, 82) substantially planar, such that the intersection of said wall (81, 82) with the tread surface (3) forms a line (811, 821) the amplitude of axial variation (A) of which is at most equal to 2% of the axial width (L) of the tread (3).

The present invention relates to a tire for a heavy-duty vehicle and concerns its tread, comprising more particularly complex and evolving cuts which open discontinuously, at regular or irregular intervals, onto the tread surface when the tire is new.

A tread, consisting of at least one rubber-based material, is the peripheral part of the tire, intended to be worn when it comes into contact with the ground via a tread surface and to grip on the ground. It generally comprises a tread pattern consisting of cuts separating raised elements.

By definition, the circumferential or longitudinal direction is the direction of rotation of the tire, the axial or transverse direction is the direction parallel to the axis of rotation of the tire and the radial direction is a direction perpendicular to the axis of rotation of the tire.

Any cut in the tread, having a mean line that is not necessarily rectilinear, that is to say one that may be undulating or zigzag, is circumferential, transverse or oblique. By convention, a cut is said to be circumferential when its mean line has a substantially circumferential mean direction, that is to say forming, with the circumferential direction, a mean angle of less than 30°. A cut is said to be transverse when its mean line has a substantially transverse mean direction, that is to say forming, with the circumferential direction, a mean angle at least equal to 60°. A cut is said to be oblique when its mean line has a substantially oblique mean direction, that is to say forms, with the circumferential direction, a mean angle of between 30° and 60°.

As is known, the wet-weather running conditions of a vehicle, and more particularly those of a heavy-duty vehicle, require rapid evacuation of the water present in the contact patch between the tread and the roadway. This evacuation makes it possible to ensure that the material constituting the tread comes into direct contact with this roadway via the tread surface. The water that is not pushed ahead of or to the sides of the tire flows or is collected partially in the cuts formed in the tread. The evacuation of the water is ensured by the cuts, which form a fluid flow network that needs to be effective throughout the service life of the tire, from new to a state of maximum wear. The state of maximum wear, which is set by the regulations in force, is the state of wear beyond which the tire needs to be removed from the vehicle for safety reasons.

The cuts allowing the evacuation of water are usually essentially wide cuts called grooves. A groove has a width such that the facing walls of material that delimit the groove do not come into contact with one another when the tread enters the contact patch, when the tire is subjected to recommended inflation and load conditions as are defined in particular by the European standards of the “European Tire and Rim Technical Organization” or “E.T.R.T.O.” in its “Standards Manual 2020-Commercial Vehicle Tires”. The deformations in compression and in shear of the raised elements delimiting the groove govern the pressures in the contact patch, and therefore wear. In addition, these deformations, by generating hysteresis losses in the material of the tread, impact the rolling resistance, and therefore the fuel consumption of the vehicle.

A tread may also comprise narrow cuts or sipes. A sipe has a width such that the facing walls of material that delimit the sipe come into contact with one another at least partially when the tread enters the contact patch, under the tire load and pressure conditions specified by the E.T.R.T.O. and set out above. A sipe does not make it possible to evacuate the water, but, with respect to the grip, has an edge corner effect in the contact patch, which makes it possible in particular to break a film of water that may be present on the ground.

In order to limit the reduction in the volume of tread material that can be worn away resulting from the presence of grooves and sipes, so-called complex cuts have been proposed which make it possible, with respect to conventional grooves, which open entirely onto the tread surface, to increase the volume of tread material while respecting the volume of cuts for water storage beyond a predetermined threshold, whatever the level of wear of the tire.

Treads comprising such complex cuts have been described in particular in documents WO2011039194, WO2011101495, WO2012130735, WO2016188956, WO2017174925, WO2019008276 and WO2019122677. A complex cut opens onto the tread surface in a discontinuous manner, at regular or irregular intervals, when new. Each complex cut has external cavities, which open onto the tread surface and are separated from one another in the main direction of the complex cut. The main direction of the complex cut is usually but not necessarily the direction in which water flows in said cut when running on ground covered in water. In addition to the external cavities, this complex cut comprises internal cavities formed inside the tread which do not open directly onto the tread surface and are generally connected to the tread surface by sipes. These internal cavities are positioned radially and entirely on the inside of the tread surface in the new state, and are interposed between the external cavities. The internal cavities may be positioned at different depth levels within the thickness of the tread. In addition, the external cavities and the internal cavities of the same complex cut are interconnected in such a way that the continuity of the flow of water in each complex cut is ensured in any state of wear of the tread, as in the case of a conventional continuous groove. On the other hand, the juxtaposition of internal and external cavities that are not connected to one another, and therefore do not allow fluid to flow from one to the other, does not constitute a continuous groove and is therefore not considered to be a complex cut.

The volume of all the internal cavities and external cavities present in a tread with complex cuts is generally less than that of all the grooves present in a conventional tread that open entirely onto the tread surface when new and have a depth corresponding to the maximum depth of the internal or external cavities. Such a tread comprising complex cuts is consequently more rigid than an equivalent tread comprising conventional open grooves.

A tread may comprise both complex cuts, opening onto the tread surface intermittently, and conventional grooves, opening onto the tread surface over their entire length.

It has been noted that heavy-duty vehicle tire treads with circumferential complex cuts positioned axially near to the edges of the tread are subject to irregular wave-shaped wear patterns through the width and thickness of the tread. These irregular wear patterns generate vibrations when the vehicle is in motion that could adversely affect comfort, notably in tires mounted on the steering axle at the front of the vehicle. This adverse effect on driving comfort may be a cause of early removal of a tire, before it is completely worn. Moreover, the presence of irregular wear patterns can lead to complete wear of certain parts of the tread, while other parts are only partially worn, hence removal of the tire with a large volume of residual wear material. Early tire removal results in economic loss for the user.

Consequently, the inventors have set themselves the objective of improving the resistance to irregular wear of a tire tread for a heavy-duty vehicle, comprising complex circumferential cuts consisting of an alternation of external cavities and of internal cavities, that is to say to delay as much as possible the appearance of irregular wear patterns on said tread, in particular on the edge ribs, each delimited by an axially outermost complex circumferential cut and a tread edge.

This objective has been achieved by a tire for a heavy-duty vehicle comprising a tread, intended to come into contact with the ground via a tread surface, having an axial width, measured in an axial direction of the tire between a first and a second tread edge,
said tread comprising at least one complex circumferential cut, delimited by raised elements, extending in a circumferential direction of the tire, and consisting, when the tire is new, of an alternation of external cavities, which open onto the tread surface, and of internal cavities, which are hidden inside the tread, two consecutive external cavities and internal cavities, respectively, being interconnected,
the at least one complex circumferential cut having an axial width, measured on the tread surface between two walls of said complex circumferential cut and variable in the circumferential direction,
the at least one complex circumferential cut having only one of its two walls substantially planar, such that the intersection of said wall with the tread surface forms a line the amplitude of axial variation of which is at most equal to 2% of the axial width of the tread.

A complex circumferential tread cut of the prior art consists, by definition, when the tire is new, of an alternation of external cavities, which open onto the tread surface, and of internal cavities, which are hidden inside the tread, two consecutive external cavities and internal cavities, respectively, being interconnected. As a result, said complex circumferential cut has an axial width, measured on the tread surface between its two walls, which is variable in the circumferential direction of the tire. This axial width is maximum at the external cavities which open onto the tread surface, and minimum at the sipes generally connecting the internal cavities, positioned inside the tread, to the tread surface. This variable axial width implies that the walls of the circumferential cut intersect the tread surface along a line that is not rectilinear, that is to say one that can vary between two end positions axially spaced apart from one another by an axial distance corresponding to the amplitude of axial variation of said line. This non-rectilinear line generates variations in contact pressure at the edge of the rib delimited by said wall, in the circumferential direction of the tire, during the rolling of the tire, in particular in connection with the Poisson effects at the edge of the rib. These pressure variations promote the initiation of irregular wear patterns on the edge of the rib in question. The invention, by proposing to limit the amplitude of axial variation of the line, typically to 2% of the width of the tread, so as to obtain a wall which is substantially planar, that is to say very close to one and the same circumferential plane over the entire circumference of the tire, makes it possible to reduce substantially the pressure variations at the edge of the rib, and therefore the risk of initiation of irregular wear patterns.

Preferably, the substantially planar wall of the at least one complex circumferential cut is strictly planar, such that the intersection of said wall with the tread surface forms a line the amplitude of axial variation of which is zero. In other words, the line of the wall is strictly rectilinear and the wall is contained in a circumferential plane. This configuration makes it possible to limit as much as possible the variations in contact pressure in the circumferential direction, at the edge of the rib delimited by said wall.

According to a preferred embodiment, the at least one complex circumferential cut having only one of its two walls substantially planar is an axially outermost complex circumferential edge cut of the tread, that is to say the furthest from a median circumferential plane perpendicular to the axis of rotation of the tire and passing through the middle of the tread. Specifically, the presence of a substantially planar wall on a complex circumferential edge cut, delimiting axially towards the inside a rib termed an intermediate rib and axially towards the outside an edge rib, is particularly advantageous in this region of the tread which is particularly sensitive to irregular wear patterns.

According to a preferred variant of the preferred embodiment described above, the substantially planar wall of the at least one complex circumferential edge cut is the axially outermost wall. The axially outermost wall of the complex circumferential edge cut delimits the edge rib, which is generally particularly sensitive to the appearance of irregular wear patterns because of its axial positioning at least partly outside the crown reinforcement and because of the generally braking forces exerted on this edge rib.

Advantageously, the edge rib, delimited by said complex circumferential edge cut and a tread edge, has an axial width at most equal to 25% of the axial width of the tread. Beyond this value, the complex circumferential edge cut delimiting said edge rib is no longer an edge cut because of its small axial distance with respect to the circumferential plane of the tire, at most equal to 30% of the tread. Consequently, it can no longer perform the expected grip and cooling functions of the crown of the tire

Also advantageously, the edge rib, delimited by said complex circumferential edge cut and a tread edge, has an axial width at least equal to 5% of the axial width of the tread. Below this value, the edge rib, because of its small axial width, is more sensitive to tearing, in particular under the action of the transverse forces exerted on the tread.

According to a particular embodiment, the tread comprises at least three, preferably at least five, complex circumferential cuts positioned between the two complex circumferential edge cuts. A sufficiently large number of ribs ensures good transverse grip because of the presence of a large number of transverse edges, and the endurance of the crown because of the cooling of the crown by a large number of cuts.

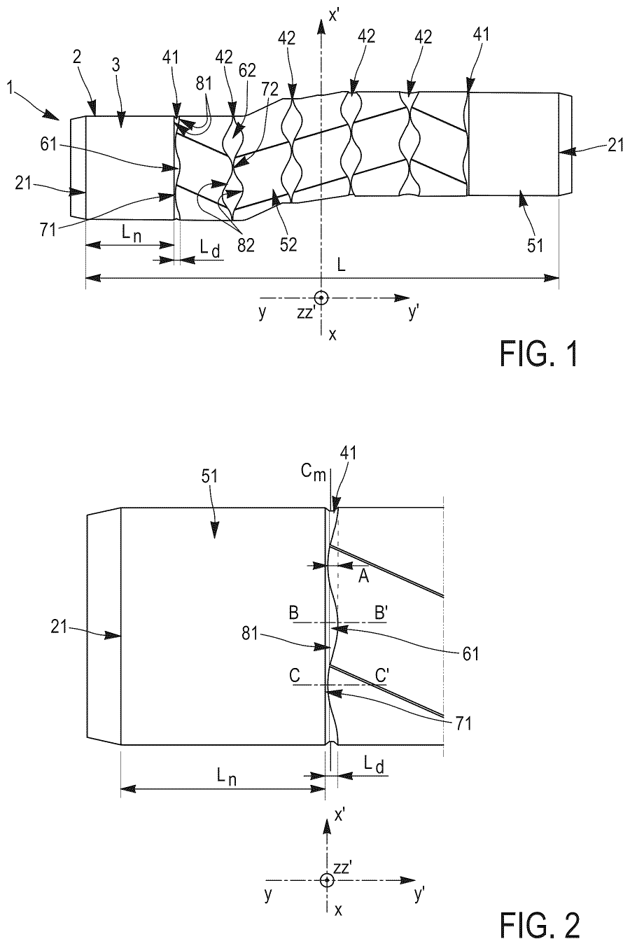

The features of the invention are illustrated by the schematic FIGS. 1 to 4, which are not drawn to scale:

FIG. 1: Top view of a tread of a tire according to the invention, with circumferential edge cuts comprising an axially outer planar wall,

FIG. 2: Top view of an edge portion of a tread of a tire according to the invention, with circumferential edge cuts comprising an axially outer planar wall,

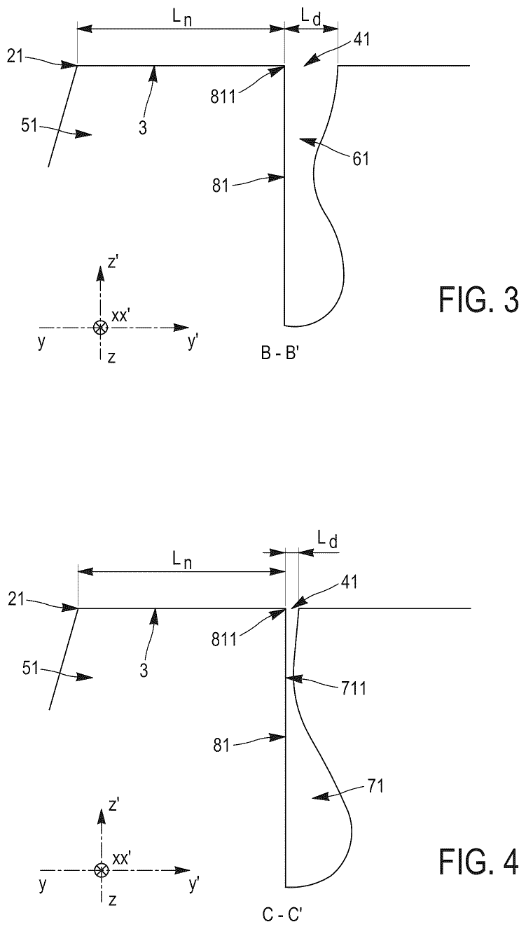

FIG. 3: View in meridian section B-B′, in a meridian plane YZ, of a complex circumferential edge cut comprising an axially outer planar wall, at an external cavity,

FIG. 4: View in meridian section C-C′, in a meridian plane YZ, of a complex circumferential edge cut comprising an axially outer planar wall, at an internal cavity.

FIG. 1 is a top view of a tread 2 of a tire 1 according to the invention. The tread 2, intended to come into contact with the ground via a tread surface 3, has an axial width L, measured in an axial direction YY′ of the tire between a first and a second tread edge 21. Said tread 2 comprises six complex circumferential cuts (41, 42), each delimited by raised elements (51, 52), extending in a circumferential direction XX′ of the tire, and each consisting, when the tire is new, of an alternation of external cavities (61, 62), which open onto the tread surface 3, and of internal cavities (71, 72), which are hidden inside the tread 2, two consecutive external cavities (61, 62) and internal cavities (71, 72), respectively, being interconnected. Of the six complex circumferential cuts (41, 42), two of them are axially outermost complex circumferential edge cuts 41 of the tread 2, that is to say the furthest from a median circumferential plane XZ perpendicular to the axis of rotation of the tire and passing through the middle of the tread 2, and four of them are intermediate complex circumferential cuts 42. Each complex circumferential cut (41, 42), whether it is an edge or intermediate cut, has an axial width Ld, measured on the tread surface 3 between two walls (81, 82) of said complex circumferential cut (41, 42) and variable in the circumferential direction XX′. In the embodiment shown in FIG. 1, each of the two complex circumferential edge cuts 41 has a strictly planar axially outer wall 81, such that the intersection of said wall 81 with the tread surface 3 forms a rectilinear line 811, that is to say the amplitude of axial variation A of which is zero. In addition, the edge rib 51, delimited by said complex circumferential edge cut 41 and a tread edge 21, has an axial width Ln at least equal to 5% and at most equal to 25% of the axial width L of the tread 2.

FIG. 2 is a top view detailing an edge portion of a tread of a tire according to the embodiment of FIG. 1. As seen in the description of FIG. 1, the complex circumferential edge cut 41 has a strictly planar axially outer wall 81, with a line 811 on the strictly rectilinear tread surface 3. In addition, the complex circumferential edge cut 41 has an axially inner wall 81 that is not substantially planar, such that the intersection of said wall 81 with the tread surface 3 forms a wavy line 811 the amplitude of axial variation A of which is strictly greater than 2% of the axial width L of the tread 2. Consequently, the complex circumferential edge cut 41 is asymmetrical with respect to its mean circumferential line Cm.

FIG. 3 is a view in meridian section B-B′, in a meridian plane YZ, of a complex circumferential edge cut 41 comprising an axially outer planar wall 81, at an external cavity 61 which opens onto the tread surface 3. The wall 81 intersects the tread surface 3 along a line 811. The complex circumferential edge cut 41 has an axial width Ld and delimits axially towards the inside an edge rib 51, the latter being delimited axially towards the outside by a tread edge 21.

FIG. 4 is a view in meridian section C-C′, in a meridian plane YZ, of a complex circumferential edge cut 41 comprising an axially outer planar wall 81, at an internal cavity 71 which does not directly open onto the tread surface 3 and is connected thereto by a sipe 711.

The inventors have more particularly studied this invention for a tire of dimension 315/70 R22.5, intended to equip a steering axle for a heavy-duty vehicle and having a load capacity of 4000 kg for an inflation pressure equal to 9 bar.

Table 1 below compares the characteristics of a tire I according to the invention and a reference tire R:

TABLE 1

| Characteristics | R | | I | | Comments |
|---|---|---|---|---|---|
| Width L of the tread | 269 | mm | 269 | mm | |
| Number of complex circumferential | 0 | | 6 | | Reference tire R having |
| cuts | | | | | open circumferential cuts |
| Type of complex circumferential | NA | | 2 | | Two complex |
| cuts having only one of its two walls | | | | | circumferential edge cuts |
| substantially planar (edge, | | | | | 41 having a planar axially |
| intermediate) | | | | | outermost wall 81 |
| Amplitude of axial variation A of the | NA | | 0 | mm | Strictly planar wall 81 |
| substantially planar wall 81 | | | | | |
| Axial width Ln of the edge rib 51 | 55 | mm | 50 | mm | Ln/L = 19%, between 5% |

and 25%

1. A tire for a heavy-duty vehicle comprising a tread, intended to come into contact with the ground via a tread surface, having an axial width (L), measured in an axial direction (YY′) of the tire between a first and a second tread edge,
said tread comprising at least one complex circumferential cut, delimited by raised elements, extending in a circumferential direction (XX′) of the tire, and consisting, when the tire is new, of an alternation of external cavities which open onto the tread surface and of internal cavities which are hidden inside the tread, two consecutive external cavities and internal cavities, respectively, being interconnected,
the at least one complex circumferential cut having an axial width (Ld), measured on the tread surface between two walls of said complex circumferential cut and variable in the circumferential direction (XX′),
wherein at least one complex circumferential cut has only one of its two walls substantially planar, such that the intersection of said wall with the tread surface forms a line the amplitude of axial variation (A) of which is at most equal to 2% of the axial width (L) of the tread.

2. The tire according to claim 1, wherein the substantially planar wall of the at least one complex circumferential cut is strictly planar, such that the intersection of said wall with the tread surface forms a line the amplitude of axial variation (A) of which is zero.

3. The tire according to claim 1, wherein the at least one complex circumferential cut having only one of its two walls substantially planar is an axially outermost complex circumferential edge cut of the tread, that is to say the furthest from a median circumferential plane (XZ) perpendicular to the axis of rotation of the tire and passing through the middle of the tread.

4. The tire according to claim 3, wherein the substantially planar wall of the at least one complex circumferential edge cut is the axially outermost wall.

5. The tire according to claim 4, wherein the edge rib, delimited by said complex circumferential edge cut and a tread edge, has an axial width (Ln) at most equal to 25% of the axial width (L) of the tread.

6. The tire according to claim 4, wherein the edge rib, delimited by said complex circumferential edge cut and a tread edge, has an axial width (Ln) at least equal to 5% of the axial width (L) of the tread.

7. The tire according to claim 1, wherein the tread comprises at least three complex circumferential cuts positioned between the two complex circumferential edge cuts.

8. The tire according to claim 1, wherein the tread comprises at least five complex circumferential cuts positioned between the two complex circumferential edge cuts.
